(19) United States
(12) Patent Application Publication
(10) Pub. No.: US 2018/0159937 A1
(43) Pub. Date: Jun. 7, 2018

(54) MONITORING SYSTEM FOR THE REAL-TIME MONITORING OF A MACHINE TOOL AND MACHINE TOOL AND TRANSCEIVER MODULE THEREFOR

(71) Applicant: KEURO Besitz GmbH & Co. EDV-Dienstleistungs KG, Achern (DE)

(72) Inventors: Armin Stolzer, Baden-Baden (DE); Sonke Florian Krebber, Baden-Baden (DE); Andreas Schorpp, Lahr-Reichenbach (DE)

(73) Assignee: KEURO Besitz GmbH & Co. EDV-Dienstleistungs KG, Achern (DE)

(21) Appl. No.: 15/415,084

(22) Filed: Jan. 25, 2017

(30) Foreign Application Priority Data
Dec. 6, 2016 (DE) 202016106787.1

(51) Int. Cl. H04L 29/08; H04B 1/40; H04M 1/725

(52) U.S. Cl. CPC H04L 67/125; H04B 1/40; H04M 1/7253; H04L 67/025; H04M 1/72561

(57) ABSTRACT

A monitoring system for the real-time monitoring of a machine tool, a transceiver module therefor, as well as a machine tool including such a transceiver module, allowing that responsible persons, for example the machine operator or a production manager, can obtain in real-time relevant information regarding status parameters at a mobile data processing device, in order to initiate or implement potentially required measures, by which processing can be optimized, or in order to monitor the optimal operation and utilization of machine groups or the entire operation. The monitoring system and/or the machine tool include an app-server or a web server, which renders available and allows obtaining and displaying the parameters obtained by the electronic machine control for an application program (app) or for a web browser of the mobile data processing device.

### INCORPORATION BY REFERENCE

The following documents are incorporated herein by reference as if fully set forth: German Patent Application No. 20 2016 106 787.1, filed Dec. 6, 2016.

### BACKGROUND

The invention relates to a monitoring system for the real-time monitoring of a machine tool, a machine tool, as well as a transceiver module for the use in a monitoring system of the present type.

Such a monitoring system comprises a portable data processing device suitable for wireless communication and a transceiver module, which is connected to an interface of an electronic machine control of the machine tool in order to detect certain status parameters of the machine tool. The transceiver module provides a communication connection to an intranet and/or it generates a wireless communication connection to the portable data processing device and/or it generates a wireless communication network.

A machine tool of the present type is provided with an electronic machine control and comprises or generates an effective connection to a transceiver module, which is connected to an interface of the machine control in order to detect certain status parameters and statistical evaluations of the machine tool.

Modern machine tools, such as sawing machines, milling machines, or the like for processing particularly metal, commonly operate in an automatic mode, i.e. an electronic machine control of the machine tool automatically runs a processing program without here it being necessary that an operator monitors the processing or even controls it by him/herself. In order to avoid downtimes it is known that such automated machine tools, in case of any malfunction which may lead to a production stop, issue an error message, which is forwarded via a transceiver module, for example operated by a telecommunication service provider, to a mobile data processing device suitable for wireless communication. This may represent for example a pager, computer, tablet, or a mobile telephone so that in case of a malfunction a technician and/or a production manager can be directly informed about the error and can introduce appropriate measures to correct the malfunction.

However, now it is desired by the production manager or another person responsible that the most important operating parameters of a machine tool can be recalled in real-time and/or monitored without having to move to the machine, in order to maintain overview of the production and to detect any need for optimization, if applicable. With growing levels of automation it also becomes increasingly important to allow recalling and/or monitoring updated status parameters of one or more machine tools in real-time even when not being located on site next to the machine tool in order to directly recall status parameters thereof.

In general, such monitoring of status parameters is possible by remote monitoring systems; however the access to a remote monitoring system is generally limited to specialized technicians of the machine manufacturer, and for safety reasons here several security devices must be engaged before a remote monitoring computer is granted access to the machine control. Such a remote monitoring system is therefore not suitable for the purposes of real-time monitoring by a machine operator and/or a production manager.

### SUMMARY

The present invention is therefore based on the objective of providing a monitoring system for the real-time monitoring of a machine tool, a transceiver module therefor, as well as a machine tool comprising such a transceiver module, allowing that responsible persons, for example the machine operator or a production manager, can obtain in real-time relevant information regarding status parameters at a mobile data processing device, in order to initiate or implement potentially required measures, by which processing can be optimized, or in order to monitor the optimal operation and utilization of machine groups or the entire operation.

This objective is attained in a monitoring system with one or more features of the invention, a machine tool with one or more features of invention, as well as a transceiver module with one or more features of the invention. Preferred embodiments of the monitoring system, advantageous further developments of the machine tool according to the invention, as well as preferred further developments of the transceiver module according to the invention are described below and in the claims.

The transceiver module according to the invention, which also characterizes the monitoring system according to the invention and the machine tool according to the invention, includes an app-server or a web server, which renders available and allows obtaining and displaying the parameters obtained by the electronic machine control for an application program (app) or for a web browser of the mobile data processing device.

A major advantage of the invention is therefore given when a smartphone or a tablet is used as the mobile data processing device suitable for wireless communication, since most people already carry a smartphone that can use the monitoring system.

When the transceiver module according to the invention includes a web server the parameters obtained from the electronic machine control become available and can be displayed cross-platform; mobile data processing devices, such as smartphones and tablets generally include an installed web browser, by which the information regarding the status parameters of the machine tool can be rendered available for display via the web browser. Depending on the manner if the transceiver module renders available the obtained status parameters via an intranet or generates a communication network and/or establishes a direct wireless communication connection to the mobile data processing device, it may be sufficient to request via the mobile data processing device a connection to the transceiver module, occurring directly or via intranet, or to directly generate such a connection, in order to have displayed interesting status parameters of the machine tool. This then occurs within the scope of the web browser of the device itself.

If the transceiver module according to the invention is equipped with an app-server it is required that a special application program (app) is installed on the mobile data processing device by which the information rendered available by the app-server of the transceiver can be obtained and displayed. As common in mobile devices, such as smartphones and tablets, the application program can be downloaded from the manufacturer of the device and/or the operating system (app store) and can be easily installed. This version of the present invention offers the advantage that for example an anonymous inquiry of the information regarding status parameters can be excluded, which increases access security.

With the present invention applicants can easily inquire, monitor, and if so required quickly react with their smartphone or tablet at any time and in a desired proximity, for example on the premises of the company, the status or the progression of relevant status parameters during operation of one or more machine tools.

When the transceiver module according to the invention provides the status parameters of the machine tool obtained via web servers it may be advantageous however to equip the mobile data processing device with an optional application (app) which graphically displays the information provided by the web server of the transceiver module with the help of a previously installed web browser in a special template. This way the user carrying the mobile data processing device is not given the impression to access the desired information via the internet. Rather, he/she assumes that a special app obtains and displays the data for the user, even when it represents technically a HTML-page, which is displayed by the application program.

According to another preferred embodiment of the present invention the transceiver module can be connected to the interface of the electronic machine control such that, in addition to obtaining status parameters, here the transmission of control commands to the machine control is possible as well. If such a transceiver module is used within the scope of a monitoring system according to the invention, the mobile data processing device shall be beneficially equipped with a selectable application program, which transmits control commands from the user, who enters them into the mobile data processing unit to the transceiver module. Therefrom the control commands are then forwarded to the electronic machine control.

With this further development of the present invention users, such as particularly machine operators or a production manager, cannot only obtain information about the present status and other status parameters of one or more machine tools in real-time, but also react immediately by transmitting control commands to a certain machine tool. Here it is possible to permit only certain control commands, such as for example an emergency shut-off or a reduction of the operating speed in order to allow reacting immediately when a dangerous situation has been detected without otherwise interfering with the machine operation. If applicable the transmission of control commands can also assume the scope such that a regular remote control of the machine tool is possible.

The transceiver module according to the invention can be embodied as a separate device; within the scope of the present invention it may however be preferred to embody the transceiver module as a part of the electronic machine control or as a virtual computer integrated in the machine control so that a machine tool is suitable to perform monitoring tasks according to the invention even without any connection to the intranet. The transceiver module according to the invention can however also be integrated in an intranet of a company and perhaps be installed as a virtual computer on a computer of said intranet.

Independent from the concrete embodiment of the transceiver module according to the invention, if necessary it can also be connected to interfaces of electronic machine control units of several machine tools.

In a monitoring system according to the invention it is particularly preferred to embody the transceiver module and the mobile data processing device such that they cooperate in the event of a malfunction of the machine tool, which is connected to a transceiver module, so that a push-message is triggered at the mobile data processing device. This represents here an alarm function, which for example immediately alerts the machine operator or a production manager even when he/she is not in a visible or audible range of the respective machine tool and its visual and/or audible alarm systems.

Another advantageous further development of the monitoring system according to the present invention comprises equipping the transceiver module according to the invention with a web server and to connect it to the internet, and to program it such that the web server responds to inquiries made to a predetermined internet address. This way it is possible via the internet to obtain practically from anywhere, even from a great distance, certain status parameters of one or more machine tools. For this purpose, the user no longer needs to be within radio range of the transceiver module and/or an intranet.

In order to conduct control commands from a user via the internet to the machine control using a transceiver module the web server of the transceiver module may be programmed such that upon an inquiry to the predetermined internet address a port forwarding is implemented to the electronic machine control in order to forward control commands to the machine control. Just like inquiries of status parameters, it is also beneficial for the implementation of port forwarding if such actions occur only upon authentication of the user.

In order to increase the safety of any access via the internet it is finally preferred for the web server of the transceiver module to be programmed such that upon an inquiry via the internet only information regarding status parameters is transmitted to the inquiring mobile data processing device, while in a direct wireless contact or an inquiry via an intranet additionally control commands are received from the inquiring data processing device and forwarded to the electronic machine control. This excludes the risk that via the internet unauthorized manipulation of the respective machine tool can occur.

### BRIEF DESCRIPTION OF THE DRAWINGS

In the following an exemplary embodiment of the present invention is described and explained in greater detail based on the attached drawings. Shown are:

FIG. 1 a schematic illustration of a monitoring system for a sawing machine embodied according to the invention; and

FIG. 2 an exemplary display on the mobile data processing device of FIG. 1.

### DETAILED DESCRIPTION OF THE PREFERRED EMBODIMENTS

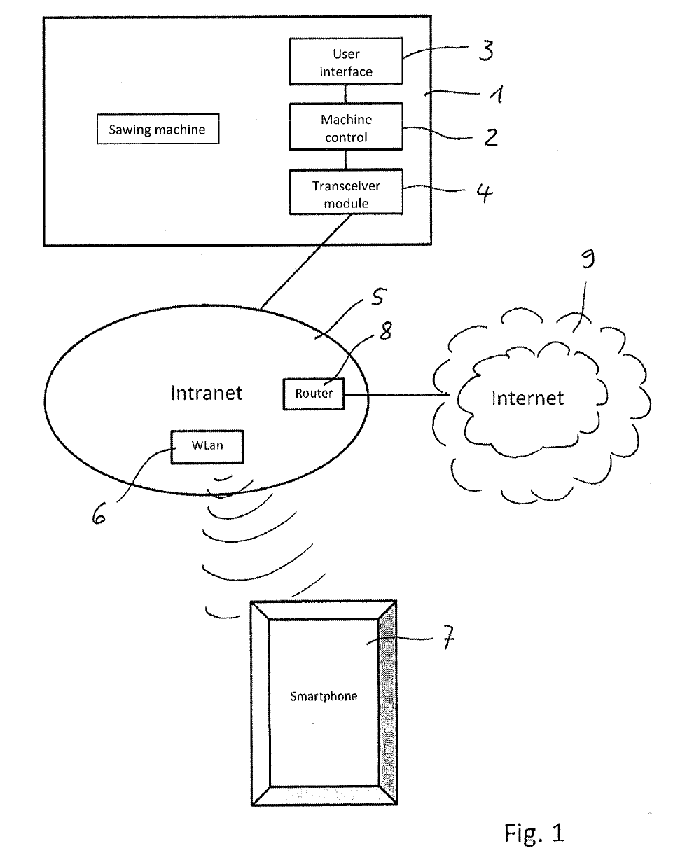

FIG. 1 is a schematic illustration for a monitoring system embodied according to the invention for the real-time monitoring of a machine tool 1, here a sawing machine of the KASTO Maschinenbau GmbH (KASTO is a registered trademark of this company). This sawing machine is provided with an electronic machine control 2, which is equipped with a user interface 3 in order to allow operating the sawing machine and monitor it on site. This user interface 3 is here a touch-sensitive display.

The machine tool 1 embodied as a sawing machine additionally comprises a transceiver module 4, which is connected to the machine control, in order to obtain status parameters therefrom. Physically the transceiver module 4 is embodied as a virtual computer within the main computer, with the machine control program 2 running there.

The transceiver module 4 is connected to an intranet 5 of a metal-processing operation, which networks several departments of the operation. The transceiver module 4 ensures that the machine tool 1 participating in the intranet 5. The intranet 5 also comprises a base station (wireless access point), which spreads a WLAN 6, allowing wireless access to the intranet 5 on the company premises. This occurs via a mobile data processing device 7 suitable for wireless communication, which in the present exemplary embodiment is a commercially available smartphone.

The intranet 5 of the present exemplary embodiment is also equipped with a router 8, by which the intranet 5 can be connected to the internet 9. The mobile data processing device 7 embodied as a smartphone can then also log onto the intranet 5 via the internet 9 and the router 8.

The transceiver module 4 of the machine tool 1 obtains certain status parameters from the electronic machine control 2 and renders them available in the intranet 5 by presenting them via a webserver in a form that can be obtained and displayed for a web browser, preferably via the HTML 5-standard.

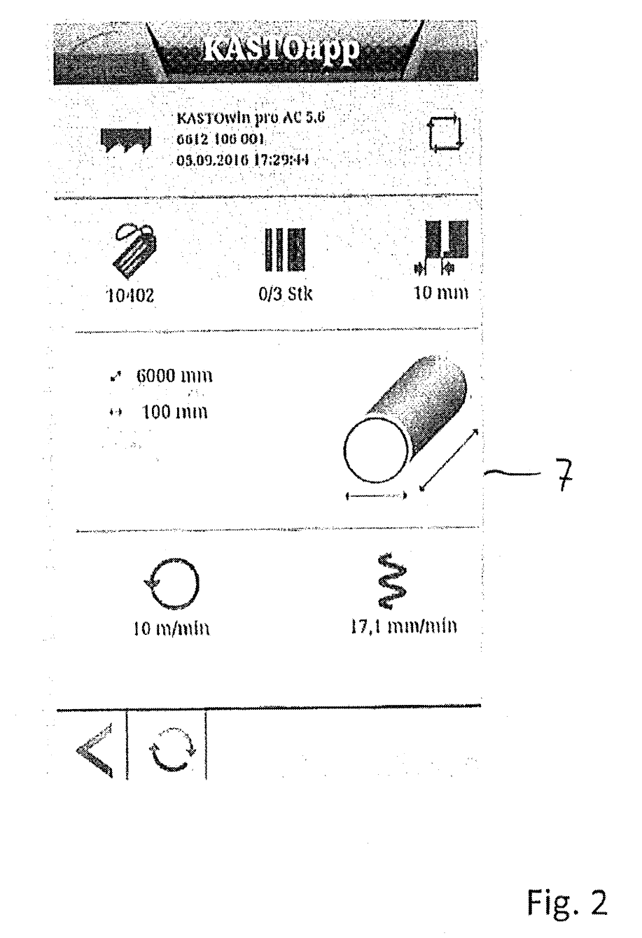

When a user logs with his/her smartphone via WLAN into the intranet 5, the smartphone can contact the transceiver module 4 and display to the user the information provided there. An example for such a display is shown in FIG. 2:

The first line informs about the identity of the respective machine tool 1: In the present case it represents the sawing machine KASTOwin pro AC 5.6, showing also its serial number next to the present date and time of the day. A symbol shown at the right indicates to the user that this machine tool 1 is presently operating and runs in the automatic mode.

In the second line the user detects which order is presently being processed by the respective sawing machine, how many sections shall be separated, and how many have already been separated, as well as the length of the section presently being sawed.

The third line offers information to the user regarding the work piece presently being processed in the sawing machine, here its length and width.

The fourth line informs the user about the processing speed of the saw band as well as the speed of the cutting motion, thus the saw feed. In the present case the saw band travels with a speed of 10 m/min and penetrates with a speed of 17.1 mm/min into the work piece.

The last line includes keypads for navigation within the application program, which in the present case is called “KASTOapp”.

If so desired the transceiver module 4 can be connected via the router 8 of the intranet 5 to the internet such that an operator with his/her smartphone can also access the transceiver module 4 via the internet from outside the company premises in order to allow displaying any status information shown in FIG. 2 and obtained by the transceiver module 4 from the electronic machine control 2.

Optionally, it is provided in the present exemplary embodiment that the transceiver module 4 not only obtains information from the electronic machine control 2 but can also issue control commands thereto. Consequently an operator can therefore transmit from his/her mobile data processing device 7, generally his/her own smartphone, control commands to the machine tool 1, namely independent from the fact where on the premises he/she is located. This may be very advantageous if here a safety shut-off shall be performed of the machine tool 1 when the operator, based on the information displayed, detects from certain status parameters that time is of the essence.

In order to exclude any manipulations from the internet it may be provided that the transceiver module 4 can only receive control commands when they are received via the intranet 5.

If no intranet 5 has been established in the company or it is not desired that the machine tool 1 becomes a part of the intranet 5, alternatively here a transceiver module 4 may be provided that directly generates a wireless connection to the mobile data processing device 7 and/or acts as a base station (wireless access point) for a separate WLAN of the machine tool 1. Here too the transceiver module 4 may be connected to the internet 9 such that the above-described functionalities can be realized.

1. A monitoring system for the real-time monitoring of a machine tool (1), comprising a mobile data processing device (7) suitable for wireless communication and a transceiver module (4) connected to an interface of an electronic machine control (2) of the machine tool (1) in order to obtain certain status parameters of the machine tool (1), which generates a communication connection to an intranet (5), and generates at least one of a wireless communication connection or a communication network, the transceiver module (4) includes an app-server or a web server which renders available and ready for display parameters obtained from the electronic machine control (2) for an application program (app) or for a web browser of the mobile data processing device (7), the transceiver module (4) is connected to the interface of the electronic machine control (2) such that in addition to obtaining the status parameters a transmission of control commands is enabled to the machine control (2), and the mobile data processing device (7) is equipped with a selectable application program, which transmits the control commands from a user to the transceiver (4) to control an operation of the machine tool, the app-server or web server of the transceiver module (4) is connected to an internet (9) and is programmed such that it answers inquiries to a predetermined internet address, and the app-server or web server of the transceiver module (4) is programmed such that upon an inquiry to the predetermined internet address a port forwarding occurs to the electronic machine control (2) in order to forward the control commands to the machine control (2).

2. The monitoring system according to claim 1, wherein the mobile data processing device (7) is equipped with a selectable application program which graphically displays information provided by the web server of the transceiver module (4) with a template of a previously installed web browser.

3. (canceled)

4. The monitoring system according to claim 1, wherein the transceiver module (4) is embodied as a part of the electronic machine control (2) or as a virtual computer integrated in the machine control (2).

5. The monitoring system according to claim 1, wherein the transceiver module (4) is connected to interfaces of electronic machine controls (2) of several additional machine tools (1).

6. The monitoring system according to claim 1, wherein the transceiver module (4) and the mobile data processing device (7) are embodied to cooperate such that in case of a malfunction of the machine tool (1) connected to the transceiver module (4), the mobile data processing device (7) is configured to trigger a push message.

7. (canceled)

8. (canceled)

9. The monitoring system according to claim 1, wherein the web server of the transceiver module (4) is programmed such that upon an inquiry via the internet (9), the transceiver module only transmits information regarding the status parameter to the inquiring mobile data processing device (7), while in case of a direct wireless contact or an inquiry via an intranet (5) additionally the transceiver module also receives control commands from the inquiring mobile data processing device (7) and forwards them to the electronic machine control (2).

10. A machine tool comprising an electronic machine control (2) and a transceiver module (4) connected to an interface of the machine control (2), wherein in order to determine certain status parameters of the machine tool (1), the transceiver module (4) includes an app-server or a web server which renders available and ready to display the parameters obtained from the electronic machine control (2) for an application program (app) or for a web browser of a mobile data processing device (7), the transceiver module (4) is connected to the interface of the electronic machine control (2) such that in addition to obtaining the status parameters a transmission of control commands is enabled to the machine control (2).

11. (canceled)

12. The machine tool according to claim 10, wherein the transceiver module (4) is embodied as a part of the electronic machine control (2) or as a virtual computer integrated in the machine control (2).

13. A transceiver module comprising an interface for an electronic machine control (2) of a machine tool (1) in order to obtain certain status parameters of the machine tool (1), and an app-server or a web server configured to render available and ready to display parameters obtained from the electronic machine control (2) for an application program (app) or for a web browser of a mobile data processing device (7), the transceiver module (4) is adapted to be connected to the interface of the electronic machine control (2) such that in addition to obtaining the status parameters a transmission of control commands is enabled to the machine control (2).

14. (canceled)

15. The transceiver module according to claim 13, wherein the transceiver module is embodied as a part of an electronic machine control (2) of a machine tool (1) or as a virtual computer integrated in said machine control (2).
